(19) United States
(12) Patent Application Publication
(10) Pub. No.: US 2009/0316867 A1
(43) Pub. Date: Dec. 24, 2009

(54) LOCATION SPECIFIC REAL-TIME TELEPHONE BROADCAST RECEIVER

(76) Inventors: Jagrut Patel, Pasadena, CA (US); Sumeet Suri, San Diego, CA (US); Vittal Prabhu, State College, PA (US)

Correspondence Address: ARENT FOX LLP, 1050 CONNECTICUT AVENUE, N.W., SUITE 400, WASHINGTON, DC, 20036, US

(21) Appl. No.: 11/736,339

(22) Filed: Apr. 17, 2007

Related U.S. Application Data
(60) Provisional application No. 60/745,007, filed on Apr. 18, 2006.

(51) Int. Cl. H04M 1/56

(52) U.S. Cl. 379/142.1

(57) ABSTRACT

A communications device includes a communication receiver. The communications receiver is configured to receive a message with location information, determine the location of the communication device, and output the message only when the communication device is within the location specified by the location information.

### CROSS-REFERENCE TO RELATED APPLICATIONS

This application is a non-provisional application claiming benefit under 35 U.S.C. sec. 119(e) of U.S. Provisional Application Ser. No. 60/745,007, filed Apr. 17, 2006, entitled “A Method and Apparatus for a Scalable Subscriber Notification System”, which is hereby incorporated by reference as though set forth in full.

### BACKGROUND

1. Field

The present disclosure relates generally to communication systems, and more particularly, to systems and techniques for real-time location specific telephone broadcast receiver.

2. Background

In today's society, the Emergency Managers increasing relying on the telephone based mass notification systems. The service providers for such mass notification system maintain large call centers that are used by the Emergency Mangers to notify the citizen population with a pre-recorded voice message. The two biggest advantage of such telephone based notification system are 1) the notification message is delivered over telephone line which happens to be one of the most commonly and widely used communication interface thus making it easy to reach children as well as elderly population who are typically not very technologically savvy and 2) The telephone being a fixed point interface associated with a known address gives much need flexibility for Emergency Manager better manage crisis by providing location specific instructions.

There are several shortcomings associated with the telephone based mass notification system. The telephone exchange has limited number of outgoing connections which is shared between large numbers of subscribers. During emergencies, telephone based mass notification system tend to initiate large number of simultaneous calls in a small region served by one or more telephone exchanges. Once the exchange reaches its maximum connection capacity, no new calls can be placed until the existing connection is released. This limits the number of people that can be simultaneously reached using the telephone based mass notification system. Further, such telephone based mass notification system is point-to-point system thus by virtue making it sequential and venerable to single point failures. Further, there is finite number of telephone lines associated with every mass notification system typically in order of few thousand lines, which is grossly inadequate to handle large crisis involving millions of individuals.

### SUMMARY

An aspect of a communication device is disclosed. The communication device includes a communication receiver configured to receive a message with location information, a receiver location configured to determine the location of the communication device, and an interface configured to provide the audio message to a person over a telephone call only when the communication device is within the location specified by the location information

An aspect of a communication device is disclosed. The communication device includes means of receiving message containing location information, means of determining the location of the communication device, means of providing the audio message to a person over a telephone call only when the communication device is within the location specified by the location information

A method of communications with a communication device is disclosed. The method includes a receiving a message with location information, determining that the communication device is within the location specified by the location information, and providing the audio message to a person over a telephone call in response to the determination that the communication device is within the location specified by the location information.

An aspect of a communication device is disclosed. The communication device includes means of receiving message containing location information, means of determining the location of the communication device, means of providing the audio message to a public address system only when the communication device is within the location specified by the location information

A method of communications with a communication device is disclosed. The method includes a receiving a message with location information, determining that the communication device is within the location specified by the location information, and providing the audio message to a public address system in response to the determination that the communication device is within the location specified by the location information.

An aspect of a communication device is disclosed. The communication device includes means of receiving message containing location information, means of determining the location of the communication device, means of interfacing to the telephone exchange and means of providing the audio message to the telephone line subscribers of the exchange only when the communication device is within the location specified by the location information

A method of communications with a communication device is disclosed. The method includes a receiving a message with location information, determining that the communication device is within the location specified by the location information, a method of interfacing the communication device with the telephone exchange and delivering the audio message to the telephone line subscribers of the exchange in response to the determination that the communication device is within the location specified by the location information.

An aspect of a communication device is disclosed. The communication device includes means of receiving message containing location information, means of determining the location of the communication device, means of interfacing to the personal computer and means of providing the received message to the personal computer user in a specified format only when the communication device is within the location specified by the location information

Computer readable media is disclosed. The computer-readable media contains set of instructions for a processor in a communication device to decode message. The communication device is configured to receive a message with location information. The instructions include a routine to determine the location of the device, and a routine to provide the audio message to a person over a telephone call only when the communications device is within the location specified by the location information.

### BRIEF DESCRIPTION OF DRAWINGS

Aspects of the present invention are illustrated by the way of example, and not by the way of limitation, in the accompanying drawings wherein:

FIG. 1 is a block diagram illustrating high level overview of a communication device.

FIG. 2 is a block diagram illustrating high level overview of a location aware communication device

FIG. 3 is a block diagram illustrating high level overview of a communication device that supports normal telephone calls as well.

FIG. 4 is a block diagram illustrating communication device being embedded into a telephone.

FIG. 5 is a block diagram illustrating high level overview of a communication device interfaced with a Public Address (PA) system.

FIG. 6 is a block diagram illustrating high level overview of a communication device interfaced with a television set.

FIG. 7 is a block diagram illustrating high level overview of a communication device interfaced with a telephone exchange.

FIG. 8 is a block diagram illustrating high level overview of a communication device interfaced with a personal computer and internet modem.

### DETAILED DESCRIPTION

The detailed description is set forth below in connection with the appended drawings are intended as a description of various embodiments of the invention and is not intended to represent the only embodiments in which the invention may be practiced. The detailed description includes specific details of the purpose of providing a thorough understanding of the invention. However, it will be apparent to those skilled in the art that the invention may be practiced without these specific details. In some instances, well-known structures and components are shown in the block diagram form in order to avoid obscuring the concepts of the invention.

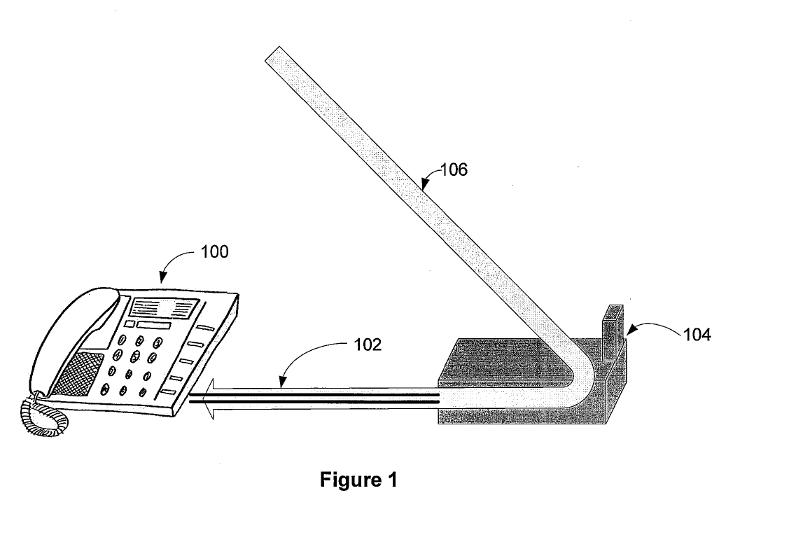

FIG. 1. is a block diagram illustrating high level overview of a communication device 104. The communication device 104 receives message 106 containing location information. The communication device 104 compares it current location with the location information from the received message 106. If the location of the communication device 104 is within the location specified by the received message 106, the communication device 104 initiates a telephone call to the telephone device 100 over telephone interface 102 (“Tip & Ring”). The communication device 104 may display the caller ID information such as “911 Emergency Call” on the telephone 100. The received message 106 is delivered to the person attending the telephone 100, when the telephone 100 receiver is picked-up in response to the ringer generated by the communication device 104.

The communication device 104 may store the received message 106 and then initiate the call to telephone 100 or may stream the message 106 to the telephone in real-time. Further, the communication device 104 may try to initiate the call to telephone 100 after some delay provided the communication device 104 was unable to deliver the message 106 in the earlier attempt. Such failed attempt may be due to an unanswered telephone call.

The personnel skilled in the art may realize that the telephone 100 may be, with no loss of generality or specificity, in any combinations of, but not limited to, analog telephone, digital telephone, cordless phone, cellular phone, IP telephone, VOIP telephone, Satellite Phone, Computer Modem, etc. Further, it may be apparent to the personnel skilled in the art that the communication device 104 can be connected to multiple telephone 100 units.

Further, the communication device 104 may operate as a standalone device or embedded inside consumer electronic device that may include in any parts or combinations of cellular phone, USB stick, fire alarm, satellite radio, am/fm radio, weather radio, TV, computer, laptop, PDA, navigation system, telephone, pager, satellite pager, etc.

Further, the communication device 104 may receive messages 106 using communication receiver, where the message is sent over an AM/FM channel, Cellular Channel (GSM, EDGE, GPRS, CDMA, WCDMA, OFDM, etc.), Paging Channel, Satellite Radio broadcast Channel, Satellite Modem Channel, Digital Audio Broadcast Channel, HD Broadcast Channel, CWB, CDPD, Satellite Phone Channel, etc. Further, the location receiver in the communication device 104 can extract the present location information of the communication device 104 using but not limited to, and in any parts or combinations of, Global Positioning System, non-GPS based positioning systems, Satellite based positioning system, Time Delay based positioning systems, Cell-Site ID, signal strength based positioning systems, triangulation based positioning systems, manually entered positioning coordinates, zip code, zip code +4, city name, telephone area code, remotely programmed coordinates, etc.

The processor in the communication device 104 may perform additional filtering of received message 106 based on the advance fields such as group based classification and filtering or based on the Device ID of the communication device 104. Such instructions may be pre-programmed into the communication device 104 or may be programmed over-the-air using a special programming message 106.

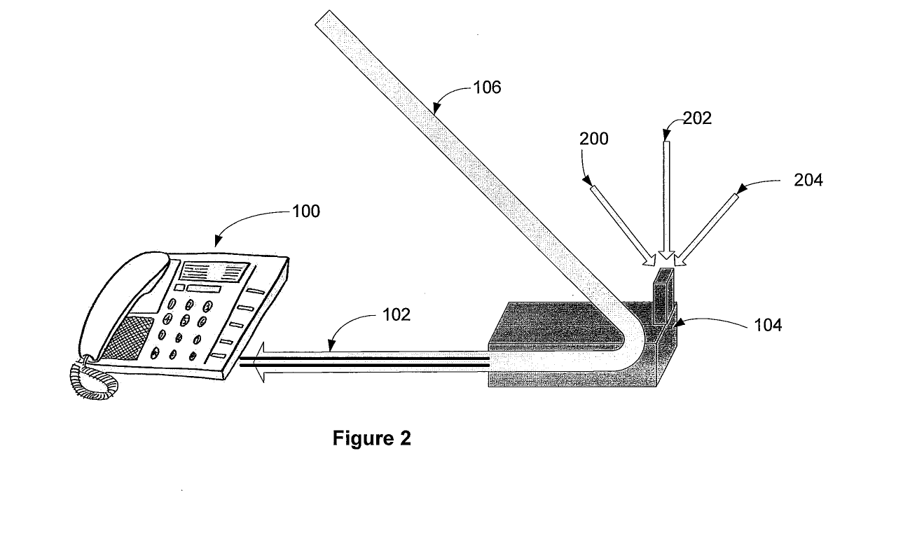

FIG. 2 is a block diagram illustrating high level overview of a location aware communication device 104. The communication device 104 has a built-in location receiver that determines the position of the communication device 104 by tracking three or more satellites signals 200, 202 and 204.

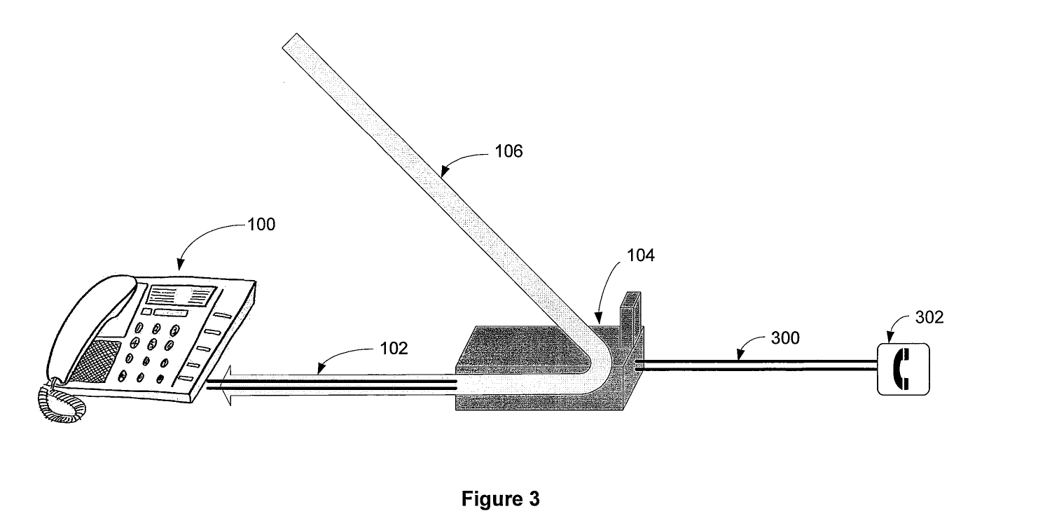

FIG. 3 is a block diagram illustrating high level overview of a communication device that supports normal telephone calls as well. The communication device 104 supports “Line-IN” and “Line-Out” interfaces. This enables easy installation of the communication device 104 in the existing telephone setup. The “Line-IN” on the communication device 104 is connected to the wall telephone socket 302 using the standard telephone cable 300. The “Line-Out” on the communication device 104 is connected to the telephone 100 using standard telephone cable 102.

The communication device 104 behaves as a pass through device during its normal operation thus enabling telephone 100 to initiate or receiver calls. When the communication device 104 receives message relevant to its location, the communication device 104 initiates call to the telephone 100 as described earlier. If there is a call in progress when the communication device 104 receives relevant message 106 to its location, the communication device 104 automatically puts the current call on the hold and delivers the received message 106 to the person attending the telephone. As a special case, the communication device 104 can be programmed to provide call waiting indication to the person attending the telephone instead of putting the existing call on hold and playing the received message 106.

The communication device 104 may draw power from the telephone connection 300/302 for charging the battery and/or operating device electronics.

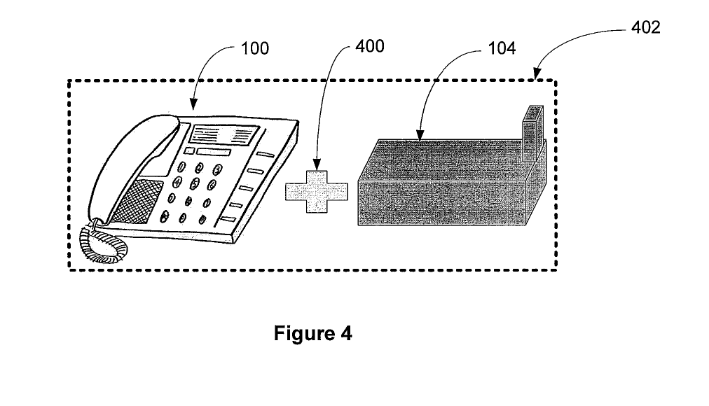

FIG. 4 is a block diagram illustrating communication device 104 being embedded into a telephone 100. This combo device 402 would enable tight integration as well as reduce in the bill of material as both these device may share common set of components 400 such as processors, power supply module, audio codec's, etc.

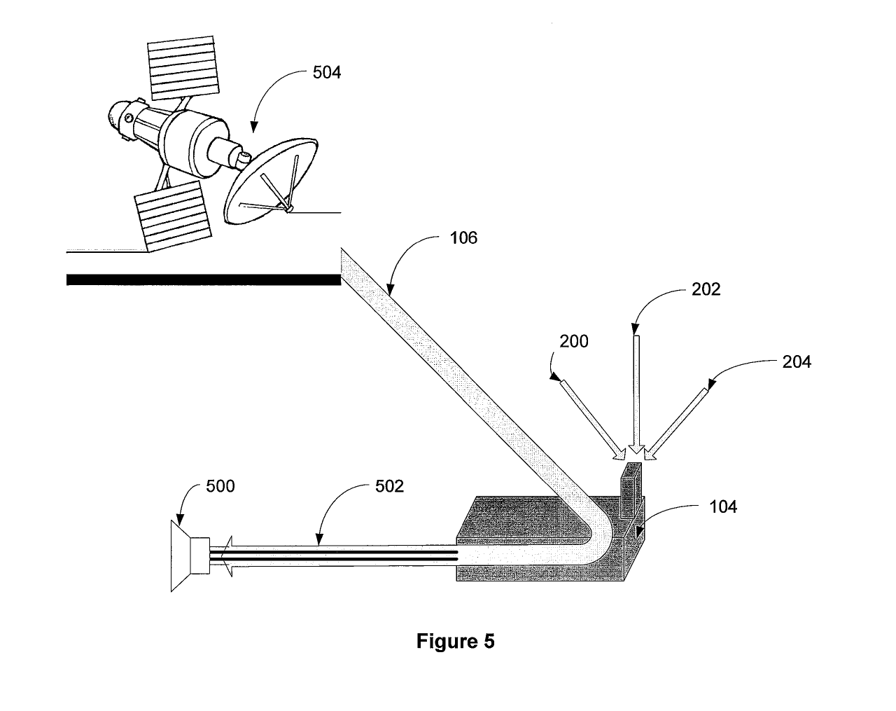

FIG. 5 is a block diagram illustrating high level overview of a communication device 104 interfaced with a Public Address (PA) system 500. The communication device 104 converts the received message 106 relevant to the communication device 104 location into mono or stereo outputs 502 which can then be connected to the Public Address system as “Line-IN”. This would enable the communication receiver to be easily set-up to address large gathering of crowd such as at the stadiums, schools, stations, airports, etc.

To the personnel skilled in the art it shall be apparent that the communication device 104 may output a control signal 502 along with the stereo outputs 502 that enables automatic switching of the amplifiers driving the PA system 500 to play the audio generated by the communication device 104.

Further, the message 106 may be transmitted by a satellite 504 to reach millions of people geotropically spread over a large area simultaneously.

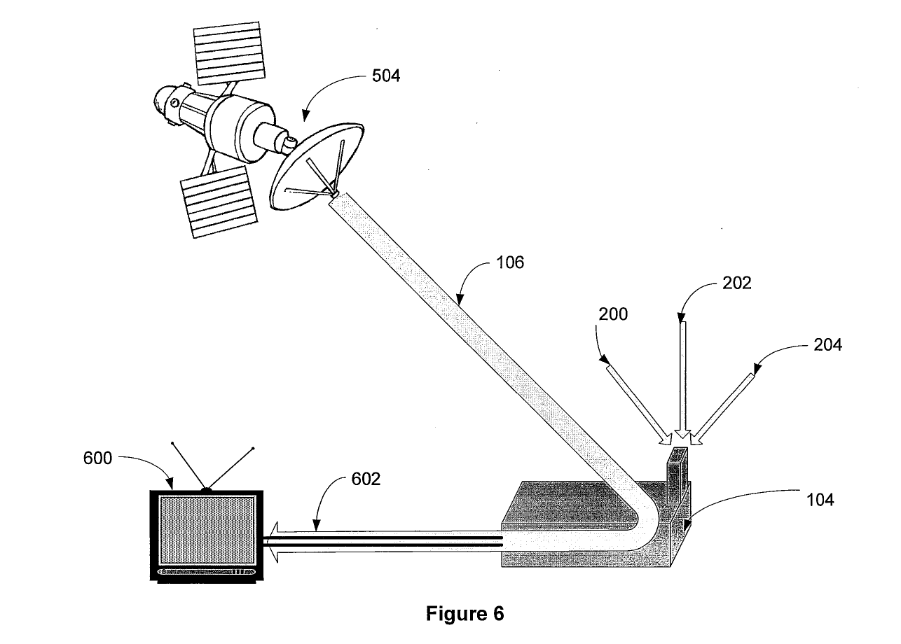

FIG. 6 is a block diagram illustrating high level overview of a communication device 104 interfaced with a television 600. The communication device 104 formats the message that is transferred set using any standard data communication interface 602 to the television 600 and is displayed on the television screen 600.

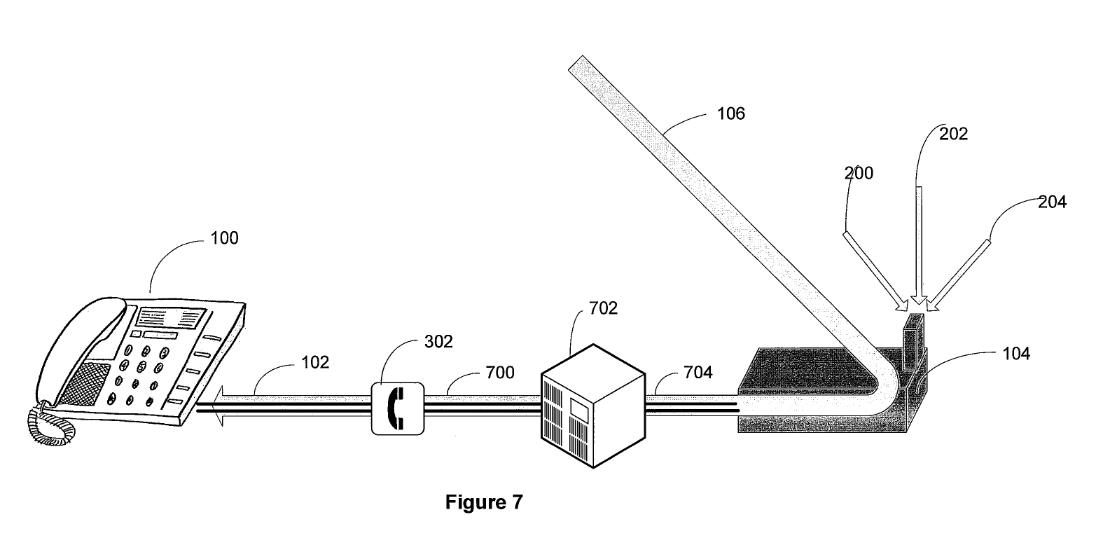

FIG. 7 is a block diagram illustrating high level overview of a communication device 104 interfaced 704 with a telephone exchange 702 and 700. The communication device 104 transfers the received message 106 relevant to the location of the communication device 104 and the exchange 702 to the exchange 702. The exchange then initiates calls to the individual telephone subscribers 100 of the exchange 702. This approach is optimal for dispatching emergency notification to large number of subscribers using the traditional calling approach. Further, to the personnel skilled in the art, it may be apparent that the communication device 104 may be interfaced to cellular network in any parts or combinations of, Mobile Switching Centers, Base Switching Center and Base Transceivers Station (BTS).

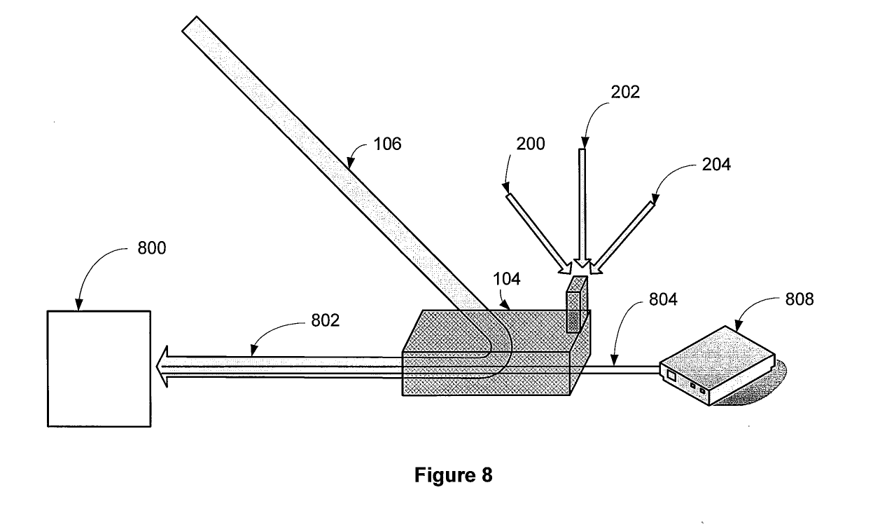

FIG. 8 is a block diagram illustrating high level overview of a communication device 104 interfaced 802/804 with a personal computer 800 and internet modem 808. The communication device 104 forwards the relevant received message 106 to the location of the communication device 104 to the personal computer 800 in the form of email, scrolling text, IM Message, pop-up window, Internet Website, etc.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language of the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A communications device, comprising:
a communication receiver configured to receive a message with location information, determine the location of the communication device, and output the message only when the communication device is within the location specified by the location information.
